(19) United States
(12) Patent Application Publication
(10) Pub. No.: US 2024/0203238 A1
(43) Pub. Date: Jun. 20, 2024

(54) Method for determining the performance of a constant false alarm rate device of a sensor and associated devices and method

(71) Applicant: THALES, Meudon (FR)

(72) Inventors: Adrien GILLIOT, MERIGNAC (FR); Vincent CORRETJA, MERIGNAC (FR)

(21) Appl. No.: 18/537,800

(22) Filed: Dec. 13, 2023

(30) Foreign Application Priority Data
Dec. 20, 2022 (FR) 2213944

(51) Int. Cl. G08B 29/04

(52) U.S. Cl. CPC G08B 29/04

(57) ABSTRACT

A method for measuring the performance of a CFAR detection system of a sensor in observing an environment, the CFAR detection system being provided with an estimator suitable for determining an estimate of parameters related to noise affecting the sensor depending on parameters related to the environment, the measurement method including estimating noise-related parameters, obtaining detection thresholds for the CFAR detection system, characterizing estimation errors of the estimator of the CFAR detection system, determining each detection threshold likely to be actually used by the CFAR system due to estimation errors, and calculating the performance of the CFAR detection system on the basis of the detection thresholds determined.

### CROSS-REFERENCE TO RELATED APPLICATIONS

This application is a U.S. non-provisional application claiming the benefit of French Application No. 22 13944, filed on Dec. 20, 2022, which is incorporated herein by reference in its entirety.

### TECHNICAL FIELD OF THE INVENTION

The present invention relates to a method for measuring the performance of a constant false alarm rate detection system of a sensor. The present invention further relates to an observation method implementing the operations of the determination method. The invention further relates to devices, namely a computer, a detection system and a vehicle.

### BACKGROUND OF THE INVENTION

In the field of detection, detection systems usually use signal processing methods. Such methods have the task of extracting, from a received signal, one or a plurality of portions corresponding to a relevant piece of information on the part of the environment which is the object of the detection.

If the case of radar is considered, the relevant piece of information corresponds to waves reflected by objects. The reflected waves or echoes may have a variable level depending on the nature and the dimensions of the objects considered.

For cases where the signal reflected by the object has a low amplitude, the processing of the radar signal seeks to extract the reflected signal from the thermal noise or the ambient clutter received by the radar receiver and which accompany the signal. The term “clutter” refers in the present case to the signal reflected by any element not subject to detection. Clutter may be, e.g., the signal reflected by elements of a terrain, constructions, bodies of water, vegetation or atmospheric phenomena such as clouds.

Such an extraction operation is, e.g., implemented by a constant false alarm rate detection system. The acronym CFAR is often used for the term “constant false alarm rate”, so the system is often referred to as the CFAR detection system.

In general, a CFAR system works by analyzing any signal received by the receiver, by implementing a sequence of operations. For example, the CFAR detection system subtracts from the incident signal an average ambient signal level. The difference is then compared to a detection threshold. Any received signal the level of which exceeds the detection threshold is considered to be representative of the presence of an object at the relevant distance corresponding to the time of reception of the signal by the radar receiver.

Thereby, the correct operation of the CFAR detection system depends very much on the accuracy of the value of the detection threshold. As a result, in practice, it is not a detection threshold but a plurality of detection thresholds which are used, the thresholds depending on the environmental conditions in which the sensor operates.

However, CFAR detection systems exhibit degraded performance under certain circumstances, in particular when the environment includes areas of different nature generating significant variations in the clutter level.

### SUMMARY OF THE INVENTION

There is thus a need for a method of measuring the performance of a constant false alarm detection system of a sensor which may be used for obtaining high quality performance measurements for all environments in which the sensor is required to work.

To this end, the description describes a method of measuring the performance of a constant false alarm rate detection system of a sensor, the sensor being suitable for observing an environment, the constant false alarm rate detection system being provided with an estimator adapted to determine an estimate of noise-related parameters affecting the sensor depending on parameters related to the environment observed by the sensor, the measurement method being implemented by a calculator and including:
estimation of parameters related to the noise affecting the sensor, in order to obtain a parameter vector,
obtaining detection thresholds for the constant false alarm detection system,
characterizing the estimation errors of the estimator of the constant false alarm rate detection system, in order to obtain parameters relating to the estimation errors,
determining the value of each detection threshold suitable for be actually used by the constant false alarm detection system due to the estimation errors of the estimator of the constant false alarm detection system for all possible configurations of the parameter vector, in order to obtain a set of determined detection thresholds, the determination using the parameters relating to the estimation errors for determining the detection threshold actually used by the constant false alarm detection system, and
calculating the performance of the constant false alarm detection system on the basis of the determined detection thresholds.

It should be understood herein that the operations are carried out without using any real data. Hence the operations may be carried out off-line, which is an important advantage of the method. The performance is obtained herein without resorting to prolonged use of the detection system so that same comes across a representative set of use cases.

In this context, a noise affecting the sensor encompasses all the contributions to the detection of the sensor, which are not a target.

The main contributions to the noises thus come from the thermal noise present in the electronic circuitry of the sensor, the clutter (radar echoes coming from the oceanic surface, the earth and/or any surface element not being a target), and atmospheric perturbations (for instance, clouds or rain).

According to particular embodiments, the measurement method has one or a plurality of the following features, taken individually or according to all technically possible combinations:
the calculating includes determination of the false alarm probability of the constant false alarm detection system with the determined detection thresholds;
during the obtaining, a false alarm probability, called an ideal false alarm probability, is also obtained, associated with the performance of the detection thresholds for an ideal operation of the constant false alarm detection system;
the performance is calculated as the ratio between the calculated false alarm probability and the ideal false alarm probability;
the parameter vector includes at least one parameter related to the thermal noise of the sensor and at least one parameter related to the noise generated by the environment the sensor observes, the at least one parameter related to the noise generated by the environment the sensor observes preferentially characterizing the sea clutter; and
during the obtaining, the detection thresholds for the constant false alarm rate detection system are computed so that, for all possible configurations of the parameter vector, the constant false alarm rate detection system operates at a predefined false alarm probability.

The description further relates to a method of observing an environment by means of a sensor suitable for observing the environment, the sensor being part of a detection system including:
a sensor suitable for observing an environment,
a constant false alarm rate detection system of the sensor provided with an estimator adapted to determine an estimate of noise-related parameters affecting the sensor according to parameters related to the environment the sensor is observing, and
a calculator,
   the observation method including:
implementing a method for measuring the performance of the constant false alarm detection system of the sensor, the measurement method being as described hereinabove,
receiving waves from the environment,
analyzing the waves received by the constant false alarm rate detection system, in order to determine if the waves include only noise, and
implementing an action according to the determined performance, the action being chosen from an alarm issuing a cancellation of the analyzing, a request to reiterate the analyzing with different thresholds, or a use of another constant false alarm detection system of the sensor when such a system is present in the detection system.

The description further relates to a calculator suitable for measuring the performance of a constant false alarm rate detection system of a sensor, the sensor being suitable for observing an environment, the constant false alarm rate detection system being provided with an estimator adapted to determine an estimate of noise-related parameters affecting the sensor depending on parameters related to the environment observed by the sensor, the calculator being adapted to:
estimate parameters related to noise affecting the sensor, in order to obtain a parameter vector,
obtain detection thresholds for the constant false alarm detection system,
characterize estimation errors of the estimator of the constant false alarm rate detection system, in order to obtain parameters relating to estimation errors, and
determine the value of each detection threshold suitable for be actually used by the constant false alarm detection system due to errors in estimates of estimator of the constant false alarm detection system for all possible configurations of the parameter vector, in order to obtain a set of determined detection thresholds, the determination using the parameters relating to the estimation errors, in order to determine the detection threshold actually used by the constant false alarm detection system, and
calculate the performance of the constant false alarm detection system on the basis of the determined detection thresholds.

The description further relates to a detection system including:
a sensor suitable for observing an environment,
a constant false alarm rate detection system of the sensor provided with an estimator adapted to determine an estimate of noise-related parameters affecting the sensor according to parameters related to the environment the sensor is observing, and
a calculator as described hereinabove.

The description further relates to a vehicle including a detection system such as described hereinabove.

In the present description, the expression “suitable for” means equally well “adapted to” or “configured for”.

### BRIEF DESCRIPTION OF THE DRAWINGS

The features and advantages of the invention will appear upon reading the following description, given only as an example, but not limited to, and making reference to the enclosed drawings, wherein:

FIG. 1 is a schematic representation of an example of vehicle;

FIG. 2 is a schematic representation of a flowchart corresponding to an example of implementation of a method for measuring the performance of a unit of the vehicle shown in FIG. 1;

FIG. 3 is a schematic representation of the element used by the implementation of an operation of the measuring method shown in FIG. 2; and

FIG. 4 is a schematic representation of an operation implemented during an operation of the measurement method shown in FIG. 2.

### DETAILED DESCRIPTION

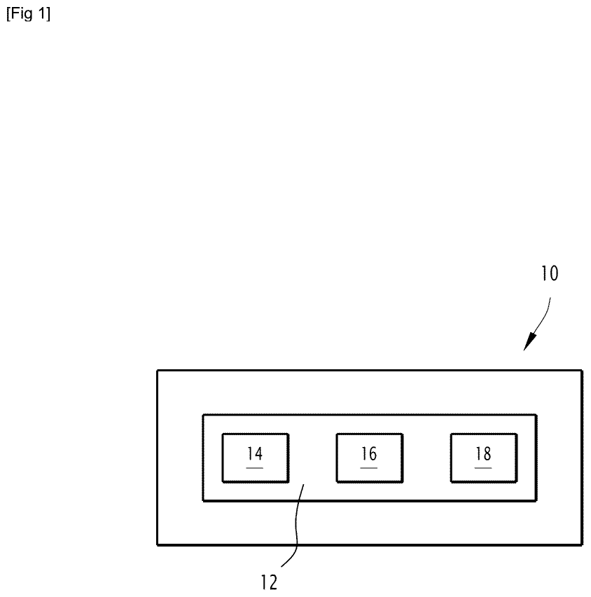

A vehicle 10 is schematically illustrated in FIG. 1.

Vehicle 10 is any type of vehicle and may be, more particularly, a land, air or sea vehicle.

Vehicle 10 includes a detection system 12 for detecting elements in an environment.

In this sense, detection system 12 may be used as a monitoring system.

Detection system 12 includes a sensor 14, a constant false alarm rate detection device 16, and a calculator 18.

Sensor 14 is, e. g., a radar.

Several types of radar may be envisaged, such as a tracking radar or a detection radar.

The radar may be used on the ground, at sea or in a mobile platform, such as an aircraft.

In a variant, sensor 14 is a sonar.

According to another variant, sensor 14 is an optronic sensor.

For example, sensor 14 is an infra-red detector or a camera.

As indicated hereinabove, CFAR detection device 16 is adapted to determine signals exceeding a detection threshold according to the environment in which sensor 14 works.

Calculator 18 is an on-board device suitable for controlling all elements of detection system 12.

According to the example described, calculator 18 is adapted to implement a method for measuring the performance of CFAR detection device 16.

For simplification, it is assumed herein that calculator 18 implements all operations of the measurement method.

However, in other embodiments, certain operations may be performed offline depending on accessible data.

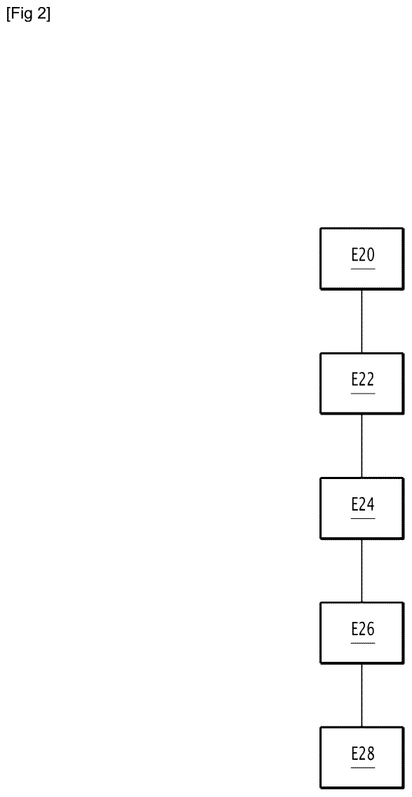

The operation of calculator 18 will now be described with reference to FIG. 2, which shows a flowchart of an example of implementation such a measurement method.

The method seeks to obtain an objective measurement of the performance of CFAR detection device 16.

The performance will be subsequently defined through specific definitions, but same reflects in each of the examples a quantification of the correct operation of CFAR detection device 16 on a plurality of use cases (or reciprocally of the number of errors).

The determination method includes, according to the example of FIG. 2, five operations which are an estimation operation E20, an obtaining operation E22, a characterization operation E24, a determination operation E26, and a computation operation E28.

During estimation operation E20, calculator 18 receives a set of observations of the environment, by means of sensor 14.

From such observations, calculator 18 estimates a parameter vector C.

The parameters of the parameter vector C are used for characterizing the phenomena leading to spurious signals at sensor 14.

Thereby, the parameters of parameter vector C are parameters characterizing the law of probability of occurrence of such phenomena.

The parameters may generally be estimated easily, in particular using the altitude, the geometry of observation or the thermal noise temperature.

Parameter vector C is thus a set of parameters related to the noises affecting sensor 14.

As a particular example, in the case of a sensor working in an environment including both air and water, the spurious phenomena or nuisances are of two types; a first phenomenon linked to sea echoes, and a second phenomenon linked to the thermal noise of detection system 12.

The first phenomenon has a power often modeled by a K(μ_{c},v) law, with μ_{c} the mean power and v the form factor of the law, describing the impulsive character of sea clutter.

In this expression, the form factor v (impulsive character) is the most determining factor.

According to the example described, the behavior of the second phenomenon is given by a parameter y, which corresponds to the average power. The thermal noise is then usually modeled by a power law such as

$$Exp ( \frac{1}{{μ}_{n}} ) .$$

Alternatively, the second phenomenon may be characterized by a parameter CNR, the acronym CNR referring to the corresponding name of “clutter-to-noise ratio”. The parameter CNR is given by the power of the sea clutter compared to the thermal noise.

Thereby, it may be envisaged in the example described that parameter vector C includes two parameters, namely the impulsive character v of the sea clutter and the parameter CNR (clutter-to-noise ratio).

Through such example, it appears that parameter vector C preferentially includes a parameter related to the thermal noise of sensor 14, and a parameter related to the noise generated by the environment that sensor 14 observes.

Thereby, calculator 18 has parameter vector C at the end of the implementation of the estimation operation E20.

Parameter vector C is suitable for taking a set of values corresponding to all possible values for each parameter. Each set of possible values is a possible configuration of the parameter vector C.

A goal of the method described is to determine the performance of CFAR detection device 16 on all possible configurations of parameter vector C.

During obtaining operation E22, calculator 18 obtains detection thresholds for CFAR detection device 16.

The detection thresholds are all the thresholds used by CFAR detection device 16 for performing the analyses thereof of an incident signal.

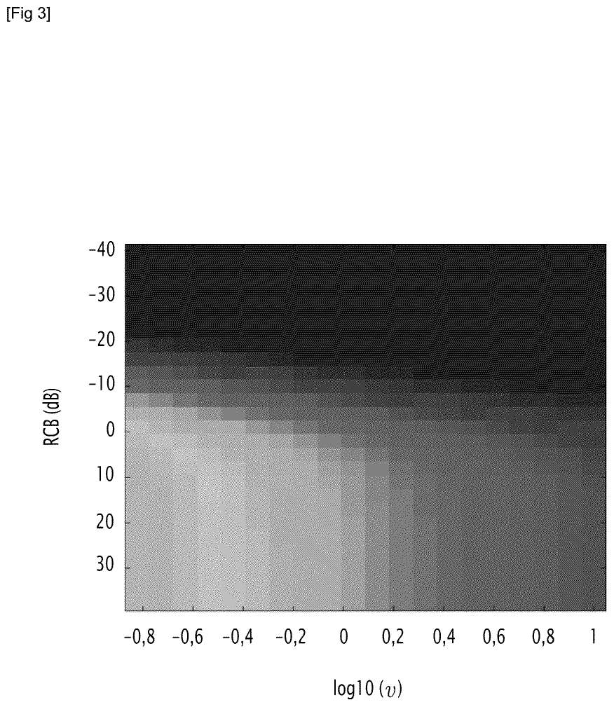

According to the particular example described, detection thresholds are provided in the form of a map visible in FIG. 3.

In this figure, the value of the threshold is represented in the form of gray levels according to the values of the impulsive character v of the sea clutter (in the form of log₁₀(v) herein) and of the parameter CNR (clutter-to-noise ratio, expressed in dB). Each gray level gives the threshold value for a box corresponding to a set of values of the two parameters.

The above thus corresponds to a table giving a value of the threshold for a value of the impulsive character v of the sea clutter and the parameter CNR (clutter-to-noise ratio).

During obtaining operation E22 according to the example described, calculator 18 also obtains a false alarm probability, called the ideal false alarm probability, associated with performance of the detection thresholds for an ideal operation of CFAR detection device 16.

All the aforementioned information (detection threshold values and the ideal false alarm probability) may be sent to calculator 18.

Alternatively, such elements may be calculated by calculator 18.

More precisely, according to one example, calculator 18 computes the detection threshold by taking into account the parameter vector and a predefined false alarm probability which corresponds to the ideal false alarm probability.

Hereinafter in the description, the predefined ideal false alarm rate is called Pfa_{ideal}.

Such a computation may be carried out by any means known to a person skilled in the art.

As a particular example for the described case of a sensor working in an environment including both air and water, calculator 18 may implement the following operations.

Calculator 18 usually determines a test statistic x maximizing the detection probability for a probability of ideal false alarm Pfa_{ideal}=1−α.

For this purpose, calculator 18 may advantageously use Swerling models, the statistical distributions of the different sources of noise (clutter and thermal noise for the example described herein), and the Neyman-Pearson Lemma.

Once the expression of the optimal test statistic is known, calculator 18 evaluates the statistical distribution fₙ(x,C) of the test statistic x under the assumption that same originates from the noise signal.

Calculator 18 obtains the distribution fₙ analytically or by implementing a Monte-Carlo method.

Calculator 18 then determines a first detection threshold S1_{Pfa}_{_{ideal}} by inverting the following integral:

$${Pfa}_{ideal} = {{\int }_{{B}_{{in}_{f}}}}^{S {1}_{{Pfa}_{ideal}}} {f}_{nuisance} ( x , C ) dx$$

with B_{inf} the lower boundary of the support of x (if x∈ [symbol] ⁺, B_{inf}=0).

For a simple law, calculator 18 may perform such an inversion analytically.

But in the complex case described, calculator 18 performs the inversion numerically at a set of points (parameterizations of C), by dichotomy.

According to another example, calculator 18 uses a least squares method combined with a gradient descent.

Thereby, at the end of obtaining operation E22, calculator 18 has computed detection thresholds for CFAR detection device 16 so that, for all possible configurations of the parameter vector, and in the absence of estimation errors on the parameter vector (i.e., calculator 18 knows perfectly the parameterization of the statistical laws of clutter and thermal noise nuisance), CFAR detection device 16 operates at a predefined ideal false alarm probability.

During characterization operation E24, calculator 18 seeks to characterize performance of the estimator denoted by Ĉ of the parameter vector C.

Estimator Ĉ is an estimator with which CFAR detection device 16 is provided.

Estimator Ĉ is suitable for determining an estimate of the parameters related to the noises affecting sensor 14 depending on parameters related to the environment that sensor 14 observes.

Example of parameters related to the environment include the altitude of vehicle 10, the type of environment (e.g., land or water) or meteorological information (presence of clouds, rain or other).

The estimator Ĉ thus corresponds to a function of CFAR detection device 16, which may take any form known to a person skilled in the art.

In the present case, it is a question of characterizing the estimation errors made by estimator Ĉ.

According to one example, performance is expressed as parameters of a distribution law.

Such an operation may be implemented by an analytical resolution when the distributions of the phenomena generating nuisances are known.

Alternatively, it is possible to use Monte Carlo methods or numerical integration methods.

According to another example, performance is expressed in the form of moments.

Denoting by C₀ the true parameter vector to be estimated, performing the characterization operation may thus consist in theoretically quantifying the first two moments of the estimator Ĉ for each parameterization C₀ (possible parameter values) of the parameter vector C.

The first two moments of the estimator Ĉ are defined as follows:

$${Bias}_{\hat{C}} ( {C}_{0} ) = E [ \hat{C} - {C}_{0} ]$$

$${Var}_{\hat{C}} ( {C}_{0} ) = E [ {( \hat{C} - {C}_{0} )}^{2} ]$$

with E[.] the mathematical expectation operator.

The first moment (Bias_{Ĉ}(C₀)) corresponds to the mean estimation error, while the second moment (Var_{Ĉ}(C₀)) corresponds to the variance of the estimation error.

It is also possible to consider higher order moments in the implementation of the characterization operation E24.

With reference to the above-mentioned example relating to a sensor working in an environment including both air and water, it is observed that CFAR detection systems 16 generally have the fault to underestimate the value of the impulsive character v of the sea clutter.

The values characterizing the performance are used for quantifying such a fault of estimation.

Hence, at the end of characterization operation E24, calculator 18 has also values characterizing the estimation errors of CFAR detection device 16.

As a remark, it will be understood that the detection thresholds take into account only the parameters of the parameter vector C and do not take into account the values characterizing the estimation performance of CFAR detection device 16. Hence, the detection thresholds are not perfectly reliable.

Determination operations E26 and calculation operations E28 calculate the reliability difference between the ideal case associated with the use of the detection thresholds by an ideal CFAR detection system and the actual use of the detection thresholds by CFAR detection device 16, which is imperfect.

During determination operation E26, calculator 18 determines the value of each detection threshold actually used by CFAR detection device 16 due to estimation errors of the estimator of CFAR detection device 16 for all the possible configurations of the parameter vector C.

For this purpose, calculator 18 determines, for a possible configuration of parameter vector C, the parameter values that the estimator c will estimate.

In an ideal case, the detection threshold used is the detection threshold corresponding to the possible configuration, the threshold being the threshold obtained.

However, due to the existence of a bias and a variance, CFAR detection device 16 considers the configuration to be another configuration or a plurality of other configurations and reads the associated threshold value.

In the worst case, the threshold value read is the minimum value of all the values read.

However, it is also possible to take an average of all the values, in order to determine the detection threshold value.

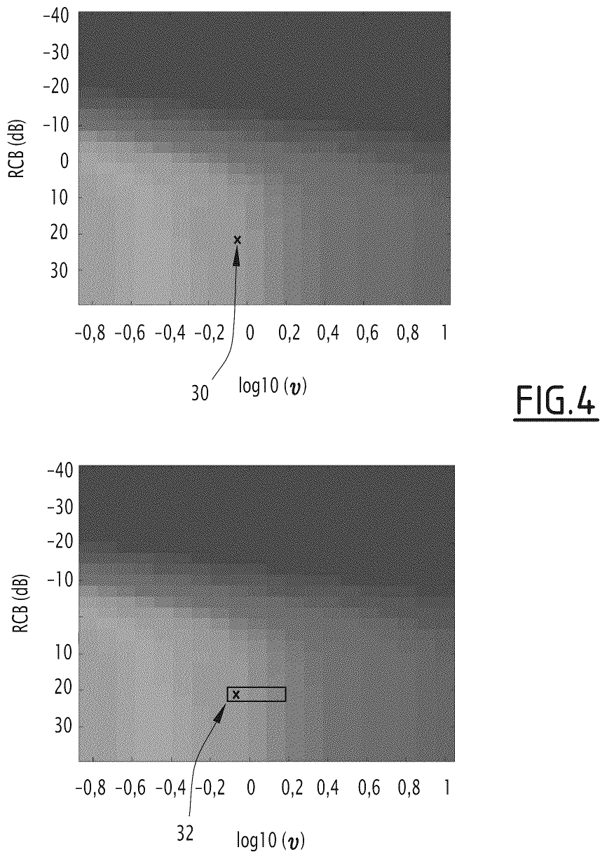

To illustrate such operation, reference is made to FIG. 4, which corresponds to an example, still for the case of a hybrid air/water detection.

The case shown in FIG. 4 corresponds to the case of a possible configuration of parameter vector C, called C₁ corresponding to C₁=[CNR₁ v₁]^{T}.

For configuration C₁, a value has been determined ensuring compliance with the ideal false alarm rate Pfa. In FIG. 4, this value is indicated by reference sign 30.

It is assumed for such configuration, the error that the estimator e is suitable for making on the estimation of the parameter CNR is less than the resolution of the graph (the size of a box in FIG. 7 is larger than the error made by estimator Ĉ on parameter CNR) whereas for the component relating to the impulsive character, estimator Ĉ is suitable for make an error of up to 4 cells. The values are derived from the calculation carried out during characterization operation E24.

All of the values of first detection thresholds CFAR detection device 16 is suitable for use taking into account the estimation errors correspond in such case to a rectangle 32 represented in FIG. 4.

Such correspondence between rectangular shape 32 and the estimation errors determined may be explained as follows.

The precise dimensioning of the zone presupposes knowing the a priori probability of appearance of each configuration of the vector of parameters C, so as to dimension X=[X_{INF},X_{SUP}] the zone actually seen by CFAR detection device 16 in the map which can be qualified so that (one-dimensional case):

$$Pfa = {\int }_{{i}_{INF}}^{{i}_{SUP}} ( {\int }_{{X}_{INF}}^{{X}_{SUP}} ( {\int }_{{T}_{marge} ( Pfa , {C}_{j} )}^{{Y}_{S U P}} {f}_{Y} ( y \vert {C}_{i} ) dy ) {f}_{\hat{C}} ( {C}_{j} \vert {C}_{i} ) {dC}_{j} ) {f}_{C} ( {C}_{i} ) {dC}_{i}$$

with:
f_{Y}(y|Cᵢ) the distribution of test statistics Y knowing the configuration Cᵢ, i being an index referring to all the configurations Cᵢ,
f_{d}(Cⱼ|Cᵢ) the distribution of the estimates given by the estimator Ĉ of the parameter vector C for the configuration Cᵢ,
f_{C}(Cᵢ) the a priori distribution of the configurations Cᵢ of the parameter vector C,
[i_{INF}, i_{SUP}] the support of parameter vector C (configurations suitable for be encountered in a real environment), and
Y_{SUP} the upper limit of the support of the test statistic Y.

Thus formulated, the problem to be solved (dimensioning of zone X) also requires having a table of margined threshold T_{marge}, which is margined using the range X.

As a first approximation, the a priori distribution of configurations Cᵢ is considered to be uniform, and the maintenance of the Pfa is approximately obtained in a simplified manner.

For the example described hereinabove, for a configuration Cᵢ of C, the characterization of the estimator Ĉ gives:
a bias vector μ_{C}_{ᵢ}, and
a covariance matrix of the error Σ_{C}_{ᵢ}

In application of the maximum entropy principle, the distribution of estimation errors of Ĉ for the configuration Cᵢ thereby corresponds to the following formula:

$$\hat{C} ∼ 𝒩 ( {μ}_{{C}_{i}} , {\sum }_{{C}_{i}} )$$

with [symbol] the normal law.

Thereby, the following criterion has to be satisfied:

$$ℙ ( \sqrt{{( \hat{C} - {μ}_{{C}_{i}} )}^{{T}_{{\sum }_{{C}_{i}}^{- 1}}} ( \hat{C} - {μ}_{{C}_{i}} )} > \frac{{X}_{S U P} - {X}_{INF}}{2} ) = c . Pfa$$

with c<1 so that the area is “sufficiently large” with respect to the predefined false alarm rate Pfa. The above corresponds to the fact that the probability that estimator Ĉ will fall out of the zone is negligible compared to the predefined false alarm rate Pfa.

In the case of a one-dimensional parameter vector C, one thus obtains:

$$\frac{{X}_{S U P} - {X}_{INF}}{2} = \sqrt{2} . {erf}^{- 1} ( 1 - c . Pfa )$$

And in general, the criterion defines the zone to be raised as an ellipsoid of equation:

$$\sqrt{{( {C}_{r} - {μ}_{{C}_{i}} )}^{{T}_{{\sum }_{{C}_{i}}^{- 1}}} ( {C}_{r} - {μ}_{{C}_{i}} )} \leq \frac{{X}_{S U P} - {X}_{INF}}{2}$$

with Cᵣ coordinates of the points to be raised.

After discretization, the ellipsoid corresponds to the rectangle visible in FIG. 4.

All the operations which have just been described are repeated for each configuration.

Calculator 18 thus determines a new detection threshold for each possible configuration. The new detection threshold is determined by the detection threshold actually used by CFAR detection device 16.

During calculation operation E28, calculator 18 calculates the performance of CFAR detection device 16 on the basis of the new detection thresholds determined.

According to the example described, calculator 18 determines the probability of false alarm of CFAR detection device 16 with the detection thresholds determined.

For this purpose, calculator 18 implements the operations which are the inverse operations of the operations described for the obtaining operation E22. wherein is explained how to derive thresholds from a given false alarm probability. Herein, the false alarm probability value will be derived from the knowledge of the thresholds.

Calculator 18 then calculates the performance as the ratio between the computed false alarm probability and the ideal false alarm probability.

The closer the value is to 1, the better the performance of CFAR detector 16.

The method which has just been described may thus be used for obtaining high quality measurements of the performance of CFAR detection device 16 for all the environments in which the sensor is required to work.

The measurement of the performance may be advantageously used within the framework of a method of observation of an environment which then includes an operation of receiving waves coming from the environment, and an operation of analyzing the waves received by CFAR detection device 16 in order to determine whether the waves include only noise, the analysis being based on the detection thresholds.

In the example described, by means of the performance measurement performed, the observation method includes an operation of implementing an action according to the determined performance.

According to a first example, the action is the issuing of an alarm.

Typically, when the performance is poor, an alarm is issued in order to indicate that the operations performed by CFAR detection device 16 are unreliable.

The alarm is, e.g., a sound or a visual alarm issued by an alarm unit that calculator 18 is adapted to trigger.

According to a second example, the action is a request to repeat the analyzing with different thresholds.

According to yet another example, the action consists in using another CFAR detection device 16 of sensor 14 when such a device 16 is present in detection system 12.

Herein, determination of the performance serves for selecting the most efficient CFAR detection device 16.

The measurement method which has just been described is thus a method for characterizing, with precision, a CFAR detection device 16.

Other embodiments of the method may be considered while leading to preserving such precision.

1. A method for measuring the performance of a constant false alarm rate detection device of a sensor, the sensor being adapted to observe an environment, the constant false alarm rate detection device being provided with an estimator adapted to determine an estimate of parameters related to noises affecting the sensor depending on parameters related to the environment observed by the sensor, the method being implemented by a calculator and comprising:
estimating parameters related to the noises affecting the sensor, in order to obtain a parameter vector;
obtaining detection thresholds for the constant false alarm rate detection device;
characterizing the estimation errors of the estimator of the constant false alarm rate detection device, in order to obtain parameters relating to the estimation errors;
determining the value of each detection threshold suitable for being actually used by the constant false alarm detection device due to the estimation errors of estimator of the constant false alarm rate for all possible configurations of the parameter vector, in order to obtain a set of determined detection thresholds, the determination using the parameters relating to the estimation errors for determining each detection threshold suitable for being actually used by the constant false alarm detection device; and
calculating the performance of the constant false alarm detection device on the basis of said determining.

2. The method for measuring according to claim 1, wherein said calculating comprises determining the false alarm probability of the constant false alarm detection device with the determined detection thresholds.

3. The method for measuring according to claim 2, wherein, during said obtaining, a false alarm probability, named ideal false alarm probability, associated with the performance of the detection thresholds for an ideal operation of the constant false alarm detection device is also obtained, and wherein the performance is calculated as the ratio between the calculated false alarm probability and the ideal false alarm probability.

4. The method for measuring according to claim 1, wherein, during said obtaining, a false alarm probability, named ideal false alarm probability, associated with the performance of the detection thresholds for an ideal operation of the constant false alarm detection device is also obtained.

5. The method for measuring according to claim 1, wherein the parameter vector includes at least a parameter related to the thermal noise of the sensor and at least a parameter related to the noise generated by the environment the sensor observes, the at least one parameter related to the noise generated by the environment the sensor observes preferentially characterizing the sea clutter.

6. The measurement method according to claim 1, wherein, during said obtaining, the detection thresholds for the constant false alarm rate detection device, are calculated so that, for all possible configurations of the parameter vector, the constant false alarm rate detection device operates at a predefined false alarm probability.

7. A method for observing an environment by a sensor adapted to observe the environment, the sensor being part of a detection system comprising:
a sensor adapted to observe an environment,
a constant false alarm rate detection device of the sensor provided with an estimator adapted to determine an estimate of parameters related to noises affecting the sensor according to parameters related to the environment the sensor is observing, and
a calculator,
the method comprising:
implementing the method of claim 1 for measuring the performance of the constant false alarm rate detection device of the sensor;
receiving waves from the environment;
analyzing the waves received by the constant false alarm rate detection device, in order to determine if the waves contain only noise; and
implementing, by the calculator, an action according to the determined performance, the action being chosen from an alarm issuing a cancellation of said analyzing, a request to reiterate said analyzing with different thresholds, or a use of another constant false alarm detection device of the sensor when such a device is present in the detection system.

8. A calculator adapted to measure the performance of a constant false alarm rate detection device of a sensor, the sensor being adapted to observe an environment, the constant false alarm rate detection device provided with an estimator adapted to determine an estimate of parameters related to noises affecting the sensor depending on parameters related to the environment observed by the sensor, the calculator being adapted to:
estimate parameters related to the noise affecting the sensor, in order to obtain a parameter vector,
obtain detection thresholds of the constant false alarm rate detection device,
characterize estimation errors of the estimator of the constant false alarm rate detection device, in order to obtain parameters relating to estimation errors,
determine the value of each detection threshold suitable for being actually used by the constant false alarm detection device due to estimation errors of the estimator of the constant false alarm detection device for all possible configurations of the parameter vector, in order to obtain a set of determined detection thresholds, the determination using the parameters relating to the estimation errors, in order to determine each detection threshold suitable for being actually used by the constant false alarm detection device, and
calculate the performance of the constant false alarm detection device on the basis of the determined detection thresholds.

9. A detection system comprising:
a sensor adapted to observe an environment;
a constant false alarm rate detection device of said sensor, comprising an estimator adapted to determine an estimate of parameters related to noises affecting said sensor according to parameters related to the environment said sensor is observing; and
a calculator according to claim 8.

10. A vehicle including a detection system according to claim 9.
